(19) United States
(12) Patent Application Publication
(10) Pub. No.: US 2026/0229113 A1
(43) Pub. Date: Aug. 6, 2026

(54) VEHICLE INTERACTION METHOD AND APPARATUS, AND SYSTEM, DEVICE AND STORAGE MEDIUM

(71) Applicant: GOERTEK TECHNOLOGY CO., LTD, Qingdao, Shandong (CN)

(72) Inventor: Bei YANG, Qingdao, Shandong (CN)

(21) Appl. No.: 19/148,144

(22) PCT Filed: Dec. 3, 2024
(86) PCT No.: PCT/CN2024/136436

§ 371 Date: Jul. 15, 2025

(30) Foreign Application Priority Data
Dec. 5, 2023 (CN) 202311660664.6

(51) Int. Cl. G08C 17/02; B60R 16/023

(52) U.S. Cl. CPC G08C 17/02; B60R 16/0231; G08C 2201/32

(57) ABSTRACT

The present application belongs to the technical field of vehicle interaction. Disclosed are a vehicle interaction method and apparatus, and a system, a device and a storage medium. The vehicle interaction method includes: acquiring orientation and position information of an intelligent remote controller in response to an interaction instruction sent by the intelligent remote controller; determining a target device that interacts with the intelligent remote controller from a plurality of interaction devices of a vehicle according to the orientation and position information; and controlling the target device to respond to the interaction instruction. The present disclosure solves the technical problem of poor convenience of interacting with the vehicle in the related art.

The present application claims the priority to a Chinese patent application No. 202311660664.6, entitled “VEHICLE INTERACTION METHOD AND APPARATUS, AND SYSTEM, DEVICE AND STORAGE MEDIUM”, filed with the China Patent Office on Dec. 5, 2023, the entire contents of which are incorporated into the present application by reference.

### TECHNICAL FIELD

The present disclosure relates to a technical field of vehicle interaction, and particularly to a vehicle interaction method and apparatus, and a system, a device and a storage medium.

### BACKGROUND

Human-machine interaction is an important component in processes of electrification, networking, intelligence and sharing of vehicles, and how to provide a safe and convenient interaction manner for users has become a main research direction for various enterprises and institutions in the industry.

A conventional human-machine interaction manner is to input an interaction instruction by a mechanical device such as a lever or a button, or a display touch device such as a touch screen. However, a function of a single button is single, which is difficult to meet multifunctional interaction with a vehicle. Besides, a position of the touch screen is disposed on a front side of a cockpit, which is difficult to meet an interaction requirement of a rear user, resulting in poor convenience of interaction with the vehicle.

The above content is merely used to assist in understanding technical solutions of the present disclosure, and does not mean that the above content is admitted to be the prior art.

### SUMMARY

A main object of the present disclosure is to provide a vehicle interaction method and apparatus, and a system, a device and a storage medium, aiming to solve a technical problem of poor convenience of conventional vehicle interaction methods.

To achieve the above object, the present disclosure provides a vehicle interaction method, including:
acquiring orientation and position information of an intelligent remote controller in response to an interaction instruction sent by the intelligent remote controller;
determining a target device that interacts with the intelligent remote controller from a plurality of interaction devices of a vehicle according to the orientation and position information; and
controlling the target device to respond to the interaction instruction.

Optionally, the intelligent remote controller is provided with an attitude sensor, and the acquiring the orientation and position information of the intelligent remote controller includes:
acquiring attitude data collected by the attitude sensor; and determining the orientation and position information of the intelligent remote controller in a vehicle's cabin coordinate system according to the attitude data.

Optionally, a front end and a rear end of the intelligent remote controller are respectively provided with at least one positioning device, identification numbers of the respective positioning devices are different from each other, and the acquiring the orientation and position information of the intelligent remote controller further includes:
acquiring coordinate information of each of the positioning devices, wherein the identification number of each positioning device is included in the coordinate information;
determining a front point and a rear point of the intelligent remote controller in a vehicle's cabin coordinate system according to the coordinate information; and generating a directional ray toward the front point by taking the rear point as an initial point, and determining the coordinate information and the directional ray as the orientation and position information.

Optionally, an interaction effective area is preset in each of the interaction devices, and the determining the target device that interacts with the intelligent remote controller from the plurality of interaction devices of the vehicle according to the orientation and position information includes:
identifying a directional ray in the orientation and position information, and determining an interaction device corresponding to the interaction effective area, through which the directional ray passes, as an effective device; and
determining the effective device with a shortest distance from an initial point of the directional ray as the target device.

Optionally, the determining the target device that interacts with the intelligent remote controller from the plurality of interaction devices of the vehicle according to the orientation and position information further includes:
dividing each of the interaction devices of the vehicle into a plurality of sub-regions in space according to a preset region division rule, wherein sizes of the sub-regions included in each of the interaction devices are increased sequentially from a center position to an edge position of each of the interaction devices;
identifying a directional ray in the orientation and position information, and determining the number of effective sub-regions in each of the interaction devices, wherein the effective sub-regions are the sub-regions through which the directional ray passes; and
determining the interaction device with a largest number of effective sub-regions as the target device.

Optionally, the controlling the target device to respond to the interaction instruction includes:
acquiring an interaction function mapping relationship matched with the target device, wherein the interaction function mapping relationship is a mapping relationship between a button signal triggered by the intelligent remote controller and an interaction function of the interaction devices; and
acquiring a target button signal in the interaction instruction, and determining a target interaction function designated by the target button signal according to the interaction function mapping relationship, to control the target device to execute the target interaction function.

Optionally, after the acquiring the orientation and position information of the intelligent remote controller, the method further includes:
if no target device is identified according to the orientation and position information, outputting a preset prompt signal to prompt a user to adjust the orientation and position of the intelligent remote controller.

The present disclosure further provides a vehicle interaction apparatus, including:
an acquisition module configured to acquire orientation and position information of an intelligent remote controller in response to an interaction instruction sent by the intelligent remote controller;
a determination module configured to determine a target device that interacts with the intelligent remote controller from a plurality of interaction devices of a vehicle according to the orientation and position information; and
a control module configured to control the target device to respond to the interaction instruction.

The present disclosure further provides a vehicle interaction system, including an intelligent remote controller and a control terminal, wherein the intelligent remote controller is communicatively connected to the control terminal, and the vehicle interaction system includes:
the intelligent remote controller configured to send an interaction instruction to the control terminal in response to a user operation; and
the control terminal configured to acquire orientation and position information of the intelligent remote controller in response to the interaction instruction sent by the intelligent remote controller; determine a target device that interacts with the intelligent remote controller from a plurality of interaction devices of a vehicle according to the orientation and position information; and control the target device to respond to the interaction instruction.

The present disclosure further provides an electronic device, including: a memory, a processor, and a vehicle interaction program stored in the memory and executable on the processor, wherein the vehicle interaction program is configured to implement steps of the vehicle interaction method described above.

The present disclosure further provides a storage medium, wherein the storage medium is a computer-readable storage medium, a vehicle interaction program is stored on the computer-readable storage medium, and the vehicle interaction program, when executed by a processor, implements steps of the vehicle interaction method described above.

The present application discloses a vehicle interaction method, including: acquiring orientation and position information of an intelligent remote controller in response to an interaction instruction sent by the intelligent remote controller; then determining a target device, which is required to interact with a user, from a plurality of interaction devices of a vehicle according to the orientation and position information of the intelligent remote controller; and then controlling the target device to respond to the interaction instruction. By the setting of the intelligent remote controller, the user at each location in the vehicle can interact with the interaction device in the vehicle, thereby improving the convenience of human-machine interaction, especially the interaction in a scenario of multiple people riding in the vehicle, meeting an interaction requirement of a passenger at each location in the vehicle, and improving user experience.

### BRIEF DESCRIPTION OF DRAWINGS

FIG. 1 is a structural schematic diagram of an electronic device in a hardware operating environment according to an embodiment of the present disclosure;

FIG. 2 is a schematic flowchart of a vehicle interaction method according to an embodiment of the present disclosure;

FIG. 3 is a structural schematic diagram of an intelligent remote controller according to an embodiment of the present disclosure;

FIG. 4 is another structural schematic diagram of an intelligent remote controller according to an embodiment of the present disclosure;

FIG. 5 is a schematic diagram of a scenario according to a second embodiment of the present disclosure;

FIG. 6 is a schematic diagram of a scenario according to a third embodiment of the present disclosure;

FIG. 7 is a schematic diagram of another scenario according to a third embodiment of the present disclosure;

FIG. 8 is a schematic flowchart according to a relatively complete embodiment of the present disclosure; and FIG. 9 is a schematic diagram of a frame structure of a vehicle interaction apparatus according to an embodiment of the present disclosure.

Implementations of the object, functional features, and advantages of the present disclosure are further described with reference to the drawings and the embodiments.

### DETAILED DESCRIPTIONS

It should be understood that, the specific embodiments described herein are merely used to explain the present disclosure and are not intended to limit the present disclosure.

In addition, descriptions such as “first” and “second” in the present disclosure are merely intended for a purpose of description, and shall not be understood as an indication or implication of relative importance or implicit indication of a number of indicated technical features. Thus, features defined with “first” and “second” may explicitly or implicitly include at least one of the features. In addition, “and/or” in the whole specification includes three solutions, taking A and/or B as an example, it includes a technical solution A, a technical solution B, and a technical solution that A and B are satisfied at the same time. In addition, the technical solutions among the various embodiments may be combined with each other, but must be based on that those skilled in the art can implement the technical solution, and when the combination of the technical solutions contradicts each other or cannot be implemented, it should be considered that the combination of the technical solutions does not exist, nor falls within the protection scope required by the present disclosure.

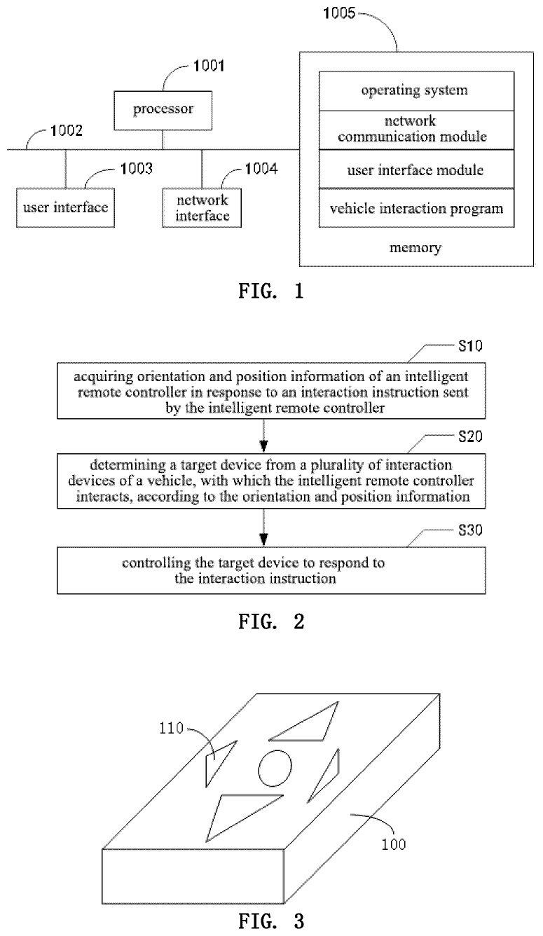

Referring to FIG. 1, FIG. 1 is a structural schematic diagram of an electronic device in a hardware operating environment according to an embodiment of the present disclosure.

As shown in FIG. 1, the electronic device may include a processor 1001, such as a central processing unit (CPU), a communication bus 1002, a user interface 1003, a network interface 1004, and a memory 1005. The communications bus 1002 is configured to implement connection and communication between these components. The user interface 1003 may include a Display, an input unit such as a Keyboard. Optionally, the user interface 1003 may further include a standard wired interface and a wireless interface. Optionally, the network interface 1004 may include a standard wired interface and a wireless interface (for example, a WI-FI interface). The memory 1005 may be a high-speed Random Access Memory (RAM), or may be a stable Non-Volatile Memory (NVM), such as a disk memory. Optionally, the memory 1005 may be a storage device independent of the processor 1001.

Those skilled in the art may understand that the structure shown in FIG. 1 does not constitute a limitation on the electronic device, and the electronic device may include more or fewer components than those shown in FIG. 1, or some components may be combined, or a different component deployment may be used.

As shown in FIG. 1, the memory 1005 as a storage medium may include an operating system, a data storage module, a network communication module, a user interface module and a vehicle interaction program.

In the electronic device shown in FIG. 1, the network interface 1004 is mainly configured to perform data communication with other devices; the user interface 1003 is mainly configured to perform data interaction with a user; and the processor 1001 and the memory 1005 in the electronic device of the present disclosure may be arranged in the electronic device, and the electronic device invokes the vehicle interaction program stored in the memory 1005 by the processor 1001 and performs the following operations:
acquiring orientation and position information of an intelligent remote controller in response to an interaction instruction sent by the intelligent remote controller;
determining a target device that interacts with the intelligent remote controller from a plurality of interaction devices of a vehicle according to the orientation and position information; and controlling the target device to respond to the interaction instruction.

Further, the intelligent remote controller is provided with an attitude sensor, and the operation of the acquiring the orientation and position information of the intelligent remote controller includes:
acquiring attitude data collected by the attitude sensor; and
determining orientation and position information and position information of the intelligent remote controller in a vehicle's cabin coordinate system of the vehicle according to the attitude data, and taking the orientation and position information and the position information as the orientation and position information.

Further, a front end and a rear end of the intelligent remote controller are respectively provided with at least one positioning device, identification numbers of the respective positioning devices are different from each other, and the operation of acquiring the orientation and position information of the intelligent remote controller further includes:
acquiring coordinate information of each of the positioning devices, wherein the identification number of each positioning device is included in the coordinate information respectively;
determining a front point and a rear point of the intelligent remote controller in a vehicle's cabin coordinate system according to the coordinate information; and generating a directional ray toward the front point by taking the rear point as an initial point, and determining the coordinate information and the directional ray as the orientation and position information.

Further, an interaction effective area is preset in each of the interaction devices, and the operation of determining the target device that interacts with the intelligent remote controller from the plurality of interaction devices of the vehicle according to the orientation and position information includes:
identifying a directional ray in the orientation and position information, and determining an interaction device corresponding to the interaction effective area, through which the directional ray passes, as an effective device; and
determining the effective device with a shortest distance from an initial point of the directional ray as the target device.

Further, the operation of determining the target device that interacts with the intelligent remote controller from the plurality of interaction devices of the vehicle according to the orientation and position information further includes:
dividing each of the interaction devices of the vehicle into a plurality of sub-regions in space according to a preset region division rule, wherein sizes of the sub-regions included in each of the interaction devices are increased sequentially from a center position to an edge position of each of the interaction devices;
identifying a directional ray in the orientation and position information, and determining the number of effective sub-regions in each of the interaction devices, wherein the effective sub-regions are the sub-regions through which the directional ray passes; and taking an interaction device with a largest number of effective sub-regions as the target device.

Further, the operation of controlling the target device to respond to the interaction instruction includes:
acquiring an interaction function mapping relationship matched with the target device, wherein the interaction function mapping relationship is a mapping relationship between a button signal triggered by the intelligent remote controller and an interaction function of the interaction device; and
acquiring a target button signal in the interaction instruction, and determining a target interaction function designated by the target button signal according to the interaction function mapping relationship, to control the target device to execute the target interaction function.

Further, the processor 1001 may invoke the vehicle interaction program stored in the memory 1005, and further perform the following operations:
after the operation of acquiring the orientation and position information of the intelligent remote controller, the method further includes:
if no target device is identified according to the orientation and position information, outputting a preset prompt signal to prompt a user to adjust the orientation and position of the intelligent remote controller.

Based on the above structure, various embodiments of the vehicle interaction method are provided.

Referring to FIG. 2, FIG. 2 is a schematic flowchart of a first embodiment of a vehicle interaction method of the present disclosure.

In this embodiment, an execution body of the vehicle interaction method may be an electronic device, and the electronic device may be a local device, for example, a central control system and an electronic control unit (ECU) of the vehicle, or may be a control terminal, and the control terminal may be a mobile terminal such as a mobile phone or a notebook, or may be a local device installed on the vehicle that is configured to respond to an interaction instruction sent by a remote controller and control each of the interaction devices on the vehicle; and the electronic device may also be a network device, which is not limited in this embodiment, and the explanation of each embodiment for the execution body is omitted for ease of description in the following. In this embodiment, the vehicle interaction method includes:

Step S10, acquiring orientation and position information of an intelligent remote controller in response to an interaction instruction sent by the intelligent remote controller.

In response to the interaction instruction sent by the intelligent remote controller, the orientation and position information of the intelligent remote controller relative to a vehicle's cabin is acquired.

Optionally, the orientation and position information may be acquired from the intelligent remote controller when an interaction instruction is received; or the orientation and position information of the intelligent remote controller relative to the vehicle's cabin may be dynamically acquired in a low power consumption manner such as background running before the interaction instruction is received, and stored locally, and then the orientation and position information is directly invoked from the background when the interaction instruction is received, so as to achieve a timely response to the interaction instruction.

Optionally, the vehicle interaction method is applied to a vehicle, and the vehicle includes a plurality of interaction devices. The interaction devices may be functional devices disposed on the vehicle, such as an air conditioner, an audio-visual entertainment system, a seat, a trunk, a sunroof, a vehicle window, etc., which is not limited in this embodiment. The user may send the interaction instruction to each interaction device on the vehicle at any position in a vehicle's cabin by using the intelligent remote controller, so that human-machine interaction between the user and each interaction device in the vehicle is no longer limited to a user's location, and the human-machine interaction between the user and the interaction device of the vehicle can be implemented at any position in the vehicle's cabin, thereby improving convenience of interaction in a scenario of multiple people riding in the vehicle, meeting an interaction requirement of a passenger at each position in the vehicle, and improving user experience.

Optionally, the intelligent remote controller is a device that can send the interaction instruction, and may be a separate newly added entity device, or may be a device that implements the sending of the interaction instruction by adding a corresponding software and hardware module to an existing device (for example, a vehicle key or a mobile phone).

For example, referring to FIG. 3, the intelligent remote controller is a physical device 100 having a plurality of universal function buttons, and a plurality of function buttons 110 are disposed on the physical device 100.

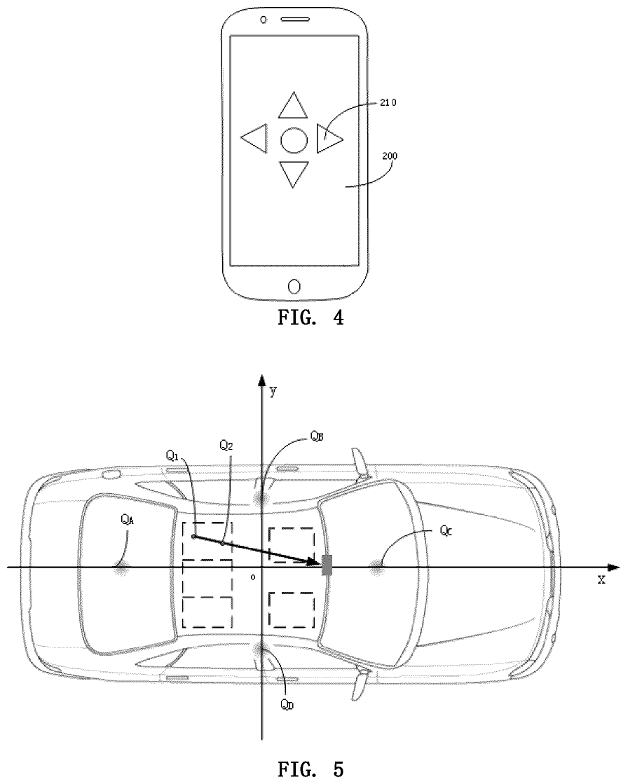

For example, referring to FIG. 4, by adding a corresponding software and hardware module to the mobile phone 200, a virtual button 210 is generated in the mobile phone 200, and it becomes an intelligent remote controller that sends an interaction instruction to each interaction device in the vehicle.

Optionally, a vehicle's cabin coordinate system is established with the cabin of the vehicle as a reference, and then coordinate positions and postures, such as a steering angle, an orientation and a pitch, of the intelligent remote controller in the vehicle's cabin coordinate system are determined as the orientation and position information.

In a feasible implementation, after the step S10 of acquiring the orientation and position information of the intelligent remote controller, the method further includes:

Step S11, if no target device is identified according to the orientation and position information, outputting a preset prompt signal to prompt the user to adjust the orientation and position of the intelligent remote controller.

A target interaction device (hereinafter referred to as a target device to differentiate them) of the user is identified according to the orientation and position information of the intelligent remote controller in the vehicle's cabin. If no target device is identified according to the orientation and position information, it indicates that there are certain problems in the position or the posture of the intelligent remote controller when the user uses the intelligent remote controller, and it is difficult to clearly identify the target interaction device of the user according to the orientation and position information of the intelligent remote controller. And a preset prompt signal is output to prompt the user to adjust the position or the posture of the intelligent remote controller.

Optionally, the prompt signal may be sent to the intelligent remote controller, so that the intelligent remote controller responds to the prompt signal, wherein the response manner may be vibration, signal light flashing, or the like, which is not limited in this embodiment.

Optionally, if the intelligent remote controller is provided with a display device, the target device may be predicted according to the orientation and position information, operation information of the vehicle, environment information, personnel information, and the like, and a prediction result is displayed by the display device of the intelligent remote controller to prompt the user to perform human-machine interaction, and the prediction result may include a predicted interaction device and an orientation of the intelligent remote controller that needs to be adjusted during that interacts with the predicted interaction device.

In a feasible implementation, if no target device is identified according to the orientation and position information, feedback is performed according to a preset feedback mechanism. The preset feedback mechanism may perform feedback by vibration of the intelligent remote controller, light flickering, outputting a prompt tone, or the like, or not responding may be as a feedback manner, which is not limited in this embodiment.

In this embodiment, if no target device is identified according to the orientation and position information, the user may be prompted to adjust the orientation of the intelligent remote controller by outputting a preset prompt signal, to implement the human-machine interaction and improve user experience.

Step S20, determining a target device that interacts with the intelligent remote controller from a plurality of interaction devices of a vehicle according to the orientation and position information.

The target device that interacts with the intelligent remote controller is determined from the plurality of interaction devices of the vehicle according to the orientation and position information of the intelligent remote controller. The orientation and position information may include position information and orientation and position information of the intelligent remote controller.

Step S30, controlling the target device to respond to the interaction instruction.

After the target device is determined, the target device is controlled to respond to the interaction instruction sent by the intelligent remote controller.

Optionally, if the control terminal is a main control system on the vehicle, after the target device is determined, the target device may be controlled to respond to the interaction instruction by a CAN bus, so that each interaction device on the vehicle may respond to the interaction instruction sent by the intelligent remote controller without additionally installing an instruction receiving device, thereby reducing the implementation cost of the vehicle interaction method; and the intelligent remote controller may interact with any vehicle by the vehicle interaction method.

In this embodiment, the vehicle interaction method includes: acquiring orientation and position information of an intelligent remote controller in response to an interaction instruction sent by the intelligent remote controller; determining a target device which is required to interact with a user from a plurality of interaction devices of a vehicle according to the orientation and position information of the intelligent remote controller; and then controlling the target device to respond to the interaction instruction. By the setting of the intelligent remote controller, the user at each position in the vehicle can interact with the interaction device in the vehicle, thereby improving the convenience of human-machine interaction, especially interaction in a scenario of multiple people riding in the vehicle, meeting an interaction requirement of a passenger at each position in the vehicle, and improving user experience.

In a feasible implementation, the step S30 of controlling the target device to respond to the interaction instruction includes:

Step S31, acquiring an interaction function mapping relationship matched with the target device, wherein the interaction function mapping relationship is a mapping relationship between a button signal triggered by the intelligent remote controller and an interaction function of the interaction device.

The interaction function mapping relationship matched with the target device is acquired, the interaction function mapping relationship is a mapping relationship between the button signal triggered by the intelligent remote controller and the interaction function of the interaction device.

Optionally, the intelligent remote controller of the present disclosure is a “universal remote controller” that sends the interaction instruction to any interaction device in the vehicle, and the intelligent remote controller is provided with a universal function button, and a corresponding specific function button may also be set according to a specific interaction device.

Step S32: acquiring a target button signal in the interaction instruction, and determining a target interaction function designated by the target button signal according to the interaction function mapping relationship, to control the target device to execute the target interaction function.

A packaged button signal (hereinafter referred to as a target button signal to differentiate them) in the interaction instruction is acquired, and the target interaction function designated by the target button signal is determined according to the interaction function mapping relationship matched with the target device, to control the target device to execute the target interaction function.

Optionally, the button signal is a button value sent after a button on the intelligent remote controller is triggered.

Optionally, the interaction function is a function executable by the interaction device of the vehicle. For example, if the target interaction device is an air conditioner, the target interaction function may be increasing or decreasing of a temperature of the air conditioner; or if the target interaction device is a seat back, the target interaction function may be adjustment of an inclination angle of the seat back, including increasing or decreasing of the inclination angle.

For example, referring to FIG. 3, the intelligent remote controller is provided with four general buttons: up, down, left and right. If the target device is an air conditioner, the user triggers the “up” button on the intelligent remote controller; and then acquires an air conditioner interaction function mapping relationship matched with the air conditioner, and determines that the target interaction function designated by the target button signal corresponding to the “up” button is increasing the temperature of the air conditioner. If the target device is a vehicle central control screen, the user triggers the “up” button on the intelligent remote controller, and then acquires a central control screen interaction function mapping relationship matched with the central control screen, and determines that the target interaction function designated by the target button signal corresponding to the “up” button points is increasing the volume.

In this embodiment, by acquiring the interaction function mapping relationship matched with each interaction device, the adaptive control of the universal function button of the intelligent remote controller on each interaction device is realized, which increases the application scenarios of the intelligent remote controller, improves the convenience of the human-machine interaction, especially in a scenario of multiple people riding in the vehicle, can meet an interaction requirement of a passenger at each position in the vehicle, and improves the user experience.

Further, based on the first embodiment, a second embodiment of the vehicle interaction method of the present disclosure is provided, and in this embodiment, the step S10 includes:

Step S12, acquiring attitude data collected by the attitude sensor; and

Step S13, determining orientation and position information and position information of the intelligent remote controller in a vehicle's cabin coordinate system according to the attitude data, and taking the orientation and position information and the position information as the orientation and position information.

The intelligent remote controller is provided with an attitude sensor, to acquire the attitude data collected by the attitude sensor of the intelligent remote controller, and calculate the orientation and position information and the position information of the intelligent remote controller in the vehicle's cabin coordinate system according to the attitude data, and take the orientation and position information and the position information as the orientation and position information of the intelligent remote controller.

Optionally, the attitude sensor may be an inertial sensor, including a gyroscope and an accelerometer, and then the orientation of the intelligent remote controller is calculated according to an angular velocity sensed by the gyroscope and an acceleration sensed by the accelerometer; and coordinate data collected by the inertial sensor is used as the position information, wherein the coordinate data may be three-dimensional coordinates or two-dimensional coordinates, which is not limited in this embodiment.

In this embodiment, by acquiring the attitude data collected by the attitude sensor disposed on the intelligent remote controller, and then determining the orientation and position information and the position information of the intelligent remote controller in the vehicle's cabin coordinate system according to the attitude data, and taking the orientation and position information and the position information as the orientation and position information, accurate identification of the position and orientation of the intelligent remote controller on the vehicle is realized.

In a feasible implementation, the step S10 of acquiring the orientation and position information of the intelligent remote controller further includes:

Step S14, acquiring coordinate information of each of the positioning devices, wherein identification number of each positioning device is included in the coordinate information respectively.

A front end and a rear end of the intelligent remote controller are provided with at least one positioning device respectively, and identification numbers used by the positioning devices are different, so that the source of the coordinate information can be determined according to the positioning device identification number packaged in the acquired coordinate information, to distinguish the front end and the rear end of the intelligent remote controller; then the coordinate information collected by the positioning device is acquired by taking the vehicle's cabin coordinate system as a reference; at least two coordinate points are included, and the coordinate points may be three-dimensional coordinate points.

Optionally, the positioning device may be an antenna, the antenna may be an Ultra Wide Band (UWB) antenna or a Bluetooth antenna. At least one antenna is provided at the front end and the rear end of the intelligent remote controller respectively, and then the front end and the rear end of the intelligent remote controller are determined by a multi-antenna technology to determine the orientation of the intelligent remote controller.

Optionally, specific identification numbers may be preset for the positioning devices at the front end and the rear end of the intelligent remote controller. For example, the front end and the rear end of the intelligent remote controller are provided with one positioning device respectively, and the positioning device is a UWB antenna, that is, the intelligent remote controller includes a front-end UWB antenna and a rear-end UWB antenna, then an identification number of the front-end UWB antenna is preset to be 1 and an identification number of the rear-end UWB antenna is preset to be 2; and then after the coordinate information of each positioning device is acquired, the source of the coordinate information may be determined by the identification number packaged in the coordinate information being 1 or 2.

For example, the front end and the rear end of the intelligent remote controller are provided with one positioning device respectively, and the positioning device is a Bluetooth antenna, that is, the intelligent remote controller includes a front-end Bluetooth antenna and a rear-end Bluetooth antenna, then an identification number of the front-end Bluetooth antenna is preset to be A and an identification number of the rear-end Bluetooth antenna is preset to be B; and then after the coordinate information of each positioning device is acquired, the source of the coordinate information may be determined by the identification number packaged in the coordinate information being A or B.

Step S15, determining a front point and a rear point of the intelligent remote controller in a vehicle's cabin coordinate system according to the coordinate information.

The front point and the rear point of the intelligent remote controller in the vehicle's cabin coordinate system is determined according to the identification number packaged in the acquired coordinate information.

Optionally, the front point may be a front end point of the intelligent remote controller, and the rear point may be a rear end point of the intelligent remote controller; or the front point may be a rear end point of the intelligent remote controller, and the rear point may be a front end point of the intelligent remote controller, which is not limited in this embodiment.

Step S16, generating a directional ray toward the front point by taking the rear point as an initial point, and determining the coordinate information and the directional ray as the orientation and position information.

A ray (hereinafter referred to as a directional ray to differentiate them) is generated in a direction toward the front point by taking the rear point as an initial point, and then the coordinate information and the directional ray are determining as the orientation and position information of the intelligent remote controller.

For example, referring to FIG. 5, a vehicle's cabin coordinate system (which may be a three-dimensional coordinate system or a two-dimensional coordinate system, and this embodiment uses the three-dimensional coordinate system as an example) is established by taking a center point of the vehicle's cabin as an origin point, and UWB anchor points, that is, four points QA, QB, QC, and QD, are set at four positions of the vehicle's cabin respectively, and dashed squares in FIG. 5 are seats in the vehicle's cabin; then UWB antennas, that is, Q1 and Q2, are set at a front end and a rear end of the intelligent remote controller respectively, and coordinate information of Q1 and Q2 are determined by setting an UWB anchor point in the vehicle; and a directional ray is generated in a direction toward the front point Q2 by taking the rear point Q1 as the initial point, and the target device of the intelligent remote controller may be determined by the interaction device in the vehicle through which the directional ray passes.

In this embodiment, the front end and the rear end of the intelligent remote controller are provided with at least one positioning device, and identification numbers used by the positioning devices are different, so that coordinate information collected by each of the positionings devices is acquired; the front point and the rear point of the intelligent remote controller in the vehicle's cabin coordinate system are determined according to the coordinate information; and then a directional ray is generated toward the front point by taking the rear point as an initial point, and the coordinate information and the directional ray are taken as the orientation and position information. In this way, the position and orientation of the intelligent remote controller on the vehicle are accurately identified.

Further, based on the above first and/or second embodiments, a third embodiment of the vehicle interaction method of the present disclosure is provided, in this embodiment, the step S20 includes:

Step S21, identifying a directional ray in the orientation and position information, and determining an interaction device corresponding to an interaction effective area through which the directional ray passes as an effective device; and

Step S22, taking the effective device with a shortest distance from an initial point of the directional ray as the target device.

An interaction effective area is preset in each interaction device of the vehicle, wherein the effective area may be a surface or a body formed by a series of points in the vehicle's cabin coordinate system, and the surface or the body may be a regular surface and/or a regular body, or may be an irregular surface and/or an irregular body, which is not limited in this embodiment; then the directional ray in the orientation and position information is identified, and an interaction effective area through which the directional ray passes is determined and the interaction device corresponding to the interaction effective area is determined as an effective device. Then, a distance between each effective device and the initial point of the directional ray is determined, and according to the principle of proximity, the effective device with the shortest distance from the initial point of the directional ray is taken as the target device.

Optionally, the condition “shortest distance” when the target device is determined may be replaced with other conditions as required, for example, an effective device with a farthest distance from the initial point of the directional ray or within a preset distance range is taken as the target device, which is not limited in this embodiment.

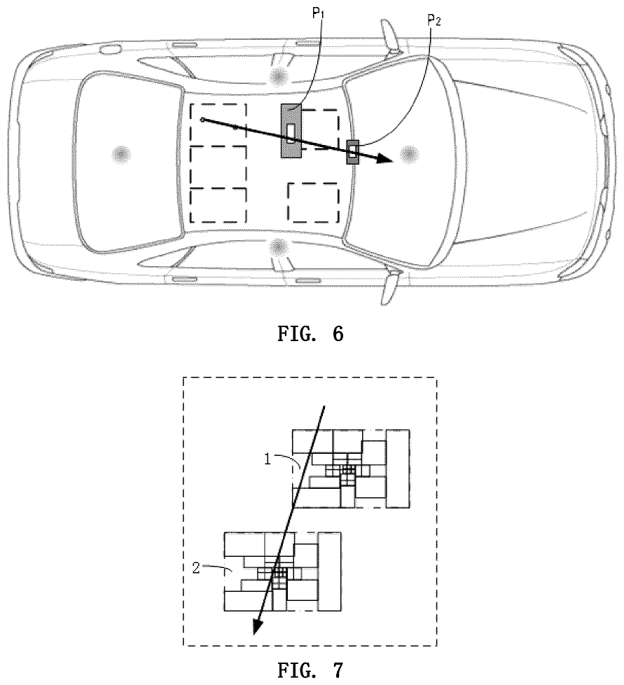

For example, referring to FIG. 6, a gray square is a spatial position of the interaction device on the vehicle, and a white square in each gray square is a preset interaction effective area in each interaction device; the directional ray in the orientation and position information of the intelligent remote controller is identified, and it is determined that the interaction device corresponding to the interaction effective area through which the directional ray passes includes: P1 and P2, taking P1 and P2 as effective devices; and the effective device with the shortest distance from the initial point of the directional ray is determined as P1, then P1 is taken as the target device.

In this embodiment, the interaction effective area is preset in each of the interaction devices, and according to a phenomenon that when using a conventional remote controller, a user will subconsciously point the remote controller towards a target device, a directional ray in the orientation and position information is identified, and the interaction device corresponding to the interaction effective area through which the directional ray passes is determined as the effective device; and then the effective device with the shortest distance from the initial point of the directional ray is taken as the target device, to implement accurate identification of the target device that interacts with the intelligent remote controller, thereby improving the convenience of human-machine interaction, especially in a scenario of multiple people riding in the vehicle, meeting the interaction requirement of a passenger at each position in the vehicle, and improving the user experience.

In a feasible implementation, the step S20 of determining the target device that interacts with the intelligent remote controller from the plurality of interaction devices of the vehicle according to the orientation and position information further includes:

Step S23, dividing each of the interaction devices of the vehicle into a plurality of sub-regions in space according to a preset region division rule, wherein sizes of sub-regions included in each of the interaction devices are increased sequentially from a center position to an edge position of each of the interaction devices.

According to the preset region division rule, that is, sizes of the sub-regions included in each of the interaction devices are increased sequentially from the center position to the edge position of each of the interaction devices, each of the interaction devices of the vehicle is divided into a plurality of sub-regions in space, wherein the size of each sub-region may be calibrated according to an actual size of each of the interaction devices of the vehicle.

Optionally, when performing sub-region division, it may be divided according to a volume of each interaction device, and the divided sub-region may include an irregular region and/or a regular region, which is not limited in this embodiment.

Step S24, identifying a directional ray in the orientation and position information, and determining the number of effective sub-regions in each of the interaction devices, wherein the effective sub-regions are the sub-regions through which the directional ray passes.

The directional ray in the orientation and position information is identified, and the sub-regions through which the directional ray pass are determined as the effective sub-regions, and then the number of effective sub-regions of each interaction device is calculated.

Step S25: Taking the interaction device with a largest number of effective sub-regions as the target device.

The interaction device with the largest number of effective sub-regions is taken as the target device.

In a feasible implementation, a number difference of effective sub-regions between an interaction device with a largest number of effective sub-regions and an interaction device with a second largest number of effective sub-regions is determined; and if the number difference is within a preset number difference range, a device with a shortest distance from the initial point of the directional ray is further taken as the target device.

Optionally, the number difference range may be set according to actual conditions, which is not limited in this embodiment.

For example, if the user sits at a position right behind a passenger seat, an inclination degree of the seat back of the passenger seat is adjusted by the intelligent remote controller. Other interaction devices, for example, an air conditioner outlet, may be arranged right in front of the passenger seat, it may be identified that a number difference between the effective sub-regions of the two interaction devices, the air conditioner outlet and the seat back of the passenger seat is within a preset number difference range; and then the device with the shortest distance from the initial point of the directional ray, that is, the seat back of the passenger seat, is taken as the target device. At the same time, if the user wants to adjust the air outlet of the air conditioner arranged directly in front of the passenger seat at the position directly behind the passenger seat, the user only needs to slightly tilt the orientation of the intelligent remote controller to make it slightly deviate from a center position of the seat back of the passenger seat, to realize the adjustment of the air outlet of the air conditioner.

For example, referring to FIG. 7, the dashed square is a vehicle's cabin, and the dotted line represents interaction devices 1 and 2 in the vehicle, and according to a preset region division rule, each interaction device of the vehicle is divided into a plurality of sub-regions in space, wherein sizes of the sub-regions included in each of the interaction devices are increased sequentially from a central position to an edge position of each of the interaction devices; a user uses an intelligent remote controller in a direction towards the interaction device 2 in front of the interaction device 1, and identifies a directional ray of the intelligent remote controller; and then according to the preset region division rule, that is, sizes of sub-regions included in each of the interaction devices are increased sequentially from a central position to an edge position of each of the interaction devices, a number of effective sub-regions of the interaction device 1 is less than a number of effective sub-regions of the interaction device 2, and it is determined that the interaction device 2 is the target device.

In this embodiment, each of the interaction devices of the vehicle is divided into a plurality of sub-regions in space according to the preset region division rule, wherein sizes of the sub-regions included in each of the interaction devices are increased sequentially from the central position to the edge position of each of the interaction devices; the directional ray in the orientation and position information is identified, and a number of effective sub-regions in each of the interaction devices is determined, wherein the effective sub-regions are the sub-region through which the directional ray passes; and the interaction device with a largest number of effective sub-regions is taken as the target device. According to the usage habits of the remote controller of the user, each of the interaction devices of the vehicle is divided into a plurality of sub-regions in space, so that the user may implement human-machine interaction with the interaction device at any position of the vehicle's cabin, thereby improving the convenience of human-vehicle interaction, especially the interaction in a scenario of multiple people riding in the vehicle, meeting an interaction requirement of a passenger at each position in the vehicle, and improving user experience.

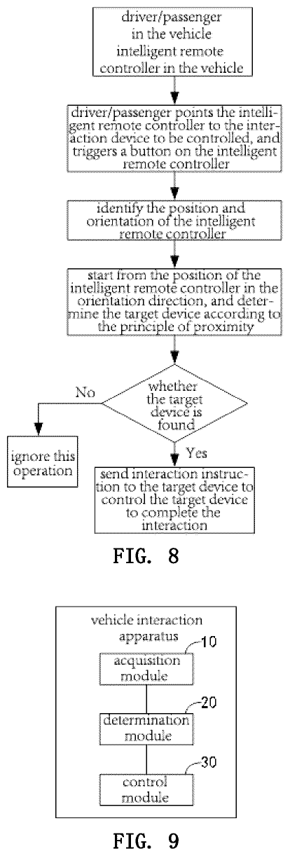

Further, based on the above first, second and/or third embodiments, a more complete embodiment of the vehicle interaction method of the present disclosure is provided. Referring to FIG. 8, a driver and/or a passenger enter the vehicle's cabin, and the intelligent remote controller is also located in the vehicle's cabin; the driver and/or the passenger points the intelligent remote controller to the interaction device to be controlled according to the interaction demand, and triggers a button on the intelligent remote controller to send an interaction instruction, wherein a button signal is packaged in the interaction instruction; then the central control system of the vehicle identifies the position and orientation of the intelligent remote controller in the vehicle's cabin, and starts from the position of the intelligent remote controller in the orientation direction, and takes the interaction device closest to the position of the intelligent remote controller as the target device according to the principle of proximity; and at the same time, it is determined whether the target device is found, if not, this operation is ignored; if yes, the interaction instruction is sent to the target device through a CAN bus to control the target device to achieve the current interaction.

Further, an embodiment of the present disclosure further provides a vehicle interaction system including an intelligent remote controller and a control terminal, wherein the intelligent remote controller is communicatively connected to the control terminal, and the vehicle interaction system includes:
the intelligent remote controller configured to send an interaction instruction to the control terminal in response to a user operation, optionally, the front end and the rear end of the intelligent remote controller are provided with at least one positioning device respectively, and identification numbers of the positioning devices are different;
the control terminal configured to acquire orientation and position information of the intelligent remote controller in response to the interaction instruction sent by the intelligent remote controller; determine a target device that interacts with the intelligent remote controller from a plurality of interaction devices of a vehicle according to the orientation and position information; and control the target device to respond to the interaction instruction.

Optionally, the control terminal is further configured to acquire attitude data collected by the attitude sensor; determine orientation and position information and position information of the intelligent remote controller in a vehicle's cabin coordinate system according to the attitude data, and take the orientation and position information and the position information as the orientation and position information.

Optionally, the control terminal is further configured to acquire coordinate information of each of the positioning devices, wherein identification numbers of the positioning devices is included in the coordinate information respectively; determine a front point and a rear point of the intelligent remote controller in a vehicle's cabin coordinate system of the vehicle according to the coordinate information; and generate a directional ray toward the front point by taking the rear point as an initial point, and take the coordinate information and the directional ray as the orientation and position information.

Optionally, the control terminal is further configured to identify an directional ray in the orientation and position information, and determine an interaction device corresponding to the interaction effective area through which the directional ray passes as an effective device, and take the effective device with a shortest distance from an initial point of the directional ray as the target device.

Optionally, the control terminal is further configured to divide each of the interaction devices of the vehicle into a plurality of sub-regions in space according to a preset region division rule, wherein sizes of sub-regions included in each of the interaction devices are increased sequentially from a center position to an edge position of each of the interaction devices; identify a directional ray in the orientation and position information, and determine a number of effective sub-regions in each of the interaction devices, wherein the effective sub-regions are sub-regions through which the directional ray passes; and take an interaction device with a largest number of effective sub-regions as the target device.

Optionally, the control terminal is further configured to acquire an interaction function mapping relationship matched with the target device, wherein the interaction function mapping relationship is a mapping relationship between a button signal triggered by the intelligent remote controller and an interaction function of the interaction devices; and acquire a target button signal in the interaction instruction, and determine a target interaction function designated by the target button signal points according to the interaction function mapping relationship, to control the target device to execute the target interaction function.

Optionally, the control terminal is further configured to output a preset prompt signal to prompt the user to adjust the orientation and position of the intelligent remote controller if no target device is identified according to the orientation and position information.

An embodiment of the present disclosure further provides a vehicle interaction apparatus. Referring to FIG. 9, the vehicle interaction apparatus is applied to an electronic device, and the vehicle interaction apparatus includes:
an acquisition module 10 configured to acquire orientation and position information of an intelligent remote controller in response to an interaction instruction sent by the intelligent remote controller;
a determination module 20 configured to determine a target device that interacts with the intelligent remote controller from a plurality of interaction devices of the vehicle according to the orientation and position information; and
a control module 30 configured to control the target device to respond to the interaction instruction.

The acquisition module 10 is further configured to output a preset prompt signal to prompt the user to adjust the orientation and position of the intelligent remote controller if no target device is identified according to the orientation and position information.

The acquisition module 10 is further configured to acquire attitude data collected by the attitude sensor; determine orientation and position information and position information of the intelligent remote controller in a vehicle's cabin coordinate system of the vehicle according to the attitude data, and take the orientation and position information and the position information as the orientation and position information.

The acquisition module 10 is further configured to acquire coordinate information of each of the positioning devices; determine a front point and a rear point of the intelligent remote controller in a vehicle's cabin coordinate system of the vehicle according to the coordinate information; and generate an directional ray toward the front point by taking the rear point as an initial point, and take the coordinate information and the directional ray as the orientation and position information.

The determination module 20 is further configured to identify a directional ray in the orientation and position information, and determine an interaction device corresponding to the interaction effective area through which the directional ray passes as an effective device, and take the effective device with a shortest distance from an initial point of the directional ray as the target device.

The determination module 20 is further configured to divide each of the interaction devices of the vehicle into a plurality of sub-regions according to a preset region division rule, wherein sizes of sub-regions included in each of the interaction devices are increased sequentially from a central position to an edge position of each of the interaction devices; identify a directional ray in the orientation and position information, and determine a number of effective sub-regions in each of the interaction devices, wherein the effective sub-regions are the sub-regions through which the directional ray passes; and take an interaction device with a largest number of effective sub-regions as the target device.

The control module 30 is further configured to acquire an interaction function mapping relationship matched with the target device, wherein the interaction function mapping relationship is a mapping relationship between a button signal triggered by the intelligent remote controller and an interaction function of the interaction devices; and acquire a target button signal in the interaction instruction, and determine a target interaction function designated by the target button signal according to the interaction function mapping relationship, to control the target device to perform the target interaction function.

Implementation of the vehicle interaction apparatus in the present disclosure is basically the same as that in the above embodiments of the vehicle interaction method, and details are not described herein again.

It should be noted that, in this specification, the terms “comprise”, “include” or any other variant thereof are intended to cover non-exclusive inclusion, so that a process, method, article or system that includes a series of elements includes not only those elements, but also other elements that are not explicitly listed, or elements inherent to such a process, method, article or system. An element defined by “comprises a . . . ” does not, without more constraints, exclude the existence of additional identical elements in the process, method, article or system that comprises the element.

Through the description of the above implementations, those skilled in the art may clearly understand that the methods in the above embodiments may be implemented by taking software and a necessary general hardware platform, or may be implemented by taking hardware, but in many cases, the former is a better implementation. Based on such understanding, the technical solutions of the present disclosure essentially or the part contributing to the prior art may be embodied in the form of a software product, and the computer software product is stored in a storage medium (such as a ROM/RAM, a magnetic disk, an optical disk) as described above, and includes several instructions for making a terminal device (which may be a mobile phone, a computer, a server, or a network device, etc.) to perform the methods described in the various embodiments of the present disclosure.

The above are only preferred embodiments of the present disclosure, and are not intended to limit the patent scope of the present disclosure, and any equivalent structure or equivalent process transformation made by taking the content of the description and the drawings of the present disclosure, or directly or indirectly application in other related technical fields, are all similarly included in the protection scope of the present disclosure.

1. A vehicle interaction method applied to a control terminal, the vehicle interaction method comprising:
acquiring orientation and position information of an intelligent remote controller in response to an interaction instruction sent by the intelligent remote controller;
determining a target device that interacts with the intelligent remote controller from a plurality of interaction devices of a vehicle according to the orientation and position information; and
controlling the target device to respond to the interaction instruction.

2. The vehicle interaction method according to claim 1, wherein the intelligent remote controller is provided with an attitude sensor, and the acquiring the orientation and position information of the intelligent remote controller comprises:
acquiring attitude data collected by the attitude sensor; and
determining the orientation and position information of the intelligent remote controller in a vehicle's cabin coordinate system according to the attitude data.

3. The vehicle interaction method according to claim 1, wherein a front end and a rear end of the intelligent remote controller are respectively provided with at least one positioning device, identification numbers of the respective positioning devices are different from each other, and the acquiring the orientation and position information of the intelligent remote controller further comprises:
acquiring coordinate information of each of the positioning devices, wherein the identification number of each positioning device is included in the coordinate information;
determining a front point and a rear point of the intelligent remote controller in a vehicle's cabin coordinate system according to the coordinate information; and
generating a directional ray toward the front point by taking the rear point as an initial point, and determining the coordinate information and the directional ray as the orientation and position information.

4. The vehicle interaction method according to claim 3, wherein an interaction effective area is preset in each of the interaction devices, and the determining the target device that interacts with the intelligent remote controller from the plurality of interaction devices of the vehicle according to the orientation and position information comprises:
identifying the directional ray in the orientation and position information, and determining an interaction device corresponding to the interaction effective area through which the directional ray passes as an effective device; and
determining the effective device with a shortest distance from the initial point of the directional ray as the target device.

5. The vehicle interaction method according to claim 3, wherein the determining the target device that interacts with the intelligent remote controller from the plurality of interaction devices of the vehicle according to the orientation and position information further comprises:
dividing each of the interaction devices of the vehicle into a plurality of sub-regions in space according to a preset region division rule, wherein sizes of the sub-regions of each of the interaction devices are increased sequentially from a center position to an edge position of each of the interaction devices;
identifying the directional ray in the orientation and position information, and determining the number of effective sub-regions in each of the interaction devices, wherein the effective sub-regions are the sub-regions through which the directional ray passes; and
determining the interaction device with a largest number of effective sub-regions as the target device.

6. The vehicle interaction method according to claim 1, wherein the controlling the target device to respond to the interaction instruction comprises:
acquiring an interaction function mapping relationship matched with the target device, wherein the interaction function mapping relationship is a mapping relationship between a button signal triggered by the intelligent remote controller and an interaction function of the interaction devices; and
acquiring a target button signal in the interaction instruction, and determining a target interaction function designated by the target button signal according to the interaction function mapping relationship, to control the target device to execute the target interaction function.

7. The vehicle interaction method according to claim 1, wherein after the acquiring the orientation and position information of the intelligent remote controller, the method further comprises:
if no target device is identified according to the orientation and position information, outputting a preset prompt signal to prompt a user to adjust the orientation and position of the intelligent remote controller.

8. A vehicle interaction apparatus, comprising:
an acquisition module configured to acquire orientation and position information of an intelligent remote controller in response to an interaction instruction sent by the intelligent remote controller;
a determination module configured to determine a target device that interacts with the intelligent remote controller from a plurality of interaction devices of a vehicle according to the orientation and position information; and
a control module configured to control the target device to respond to the interaction instruction.

9. A vehicle interaction system, comprising an intelligent remote controller and a control terminal, wherein the intelligent remote controller is communicatively connected to the control terminal, and the vehicle interaction system comprises:
the intelligent remote controller configured to send an interaction instruction to the control terminal in response to a user operation; and
the control terminal configured to acquire orientation and position information of the intelligent remote controller in response to the interaction instruction sent by the intelligent remote controller; determine a target device that interacts with the intelligent remote controller from a plurality of interaction devices of a vehicle according to the orientation and position information; and control the target device to respond to the interaction instruction.

10. An electronic device, comprising: a memory, a processor, and a vehicle interaction program stored in the memory and executable on the processor, wherein the vehicle interaction program is configured to implement steps of the vehicle interaction method according to claim 1.

11. A storage medium, on which a vehicle interaction program is stored, wherein the vehicle interaction program, when executed by a processor, implements steps of the vehicle interaction method according to claim 1.
